(19) United States
(12) Patent Application Publication
(10) Pub. No.: US 2022/0352840 A1
(43) Pub. Date: Nov. 3, 2022

(54) THREE-PHASE DC MOTOR DRIVING CIRCUIT, COOLING DEVICE AND ELECTRONIC MACHINE USING THEREOF

(71) Applicant: ROHM CO., LTD., Kyoto-shi (JP)

(72) Inventors: Hiroyuki SHIMIZU, Kyoto-shi (JP); Joji NOIE, Kyoto-shi (JP); Shinsuke SANO, Kyoto-shi (JP); Yuji SAEGUSA, Kyoto-shi (JP)

(21) Appl. No.: 17/729,636

(22) Filed: Apr. 26, 2022

(30) Foreign Application Priority Data
Apr. 30, 2021 (JP) 2021-077043

(51) Int. Cl. H02P 27/08

(52) U.S. Cl. CPC H02P 27/085

(57) ABSTRACT

The present disclosure provides a motor driving circuit of capable of stopping operation within a short period of time. A bridge circuit of the present disclosure is connected to a fan motor. In response to a stop instruction, a control logic circuit fixes an upper arm of a source phase in which a current flows out to be off in the bridge circuit, and maintains statuses of other upper arms and lower arms. The control logic circuit then fixes the upper arms and the lower arms of all phases of the bridge circuit to be off.

### CROSS REFERENCES TO RELATED APPLICATIONS

The present invention claims priority under 35 U.S.C. § 119 to Japanese Application, 2021-077043, filed on Apr. 30, 2021, the entire contents of which being incorporated herein by reference.

### TECHNICAL FIELD

The present disclosure relates to a fan motor driving technique.

### BACKGROUND

A fan motor used for temperature control is mounted on a laptop computer or desktop computer, an information processing apparatus such as a workstation, an entertainment machine such as a gaming machine, a projector or a surveillance camera, a home appliance such as a microwave or a refrigerator, or a vehicle. A fan motor directly blows a heat source such as a central processing unit (CPU) and draws fresh air from outside to inside of a casing or discharges heated air.

In certain purposes that strongly demand reduced power consumption, the fan motor may frequently switch between being stopped and rotating. By taking reduction of power consumption of an entire system into consideration, a driving circuit of the fan motor needs to stop operating as quickly as possible after receiving a stop instruction from a host controller.

### PRIOR ART DOCUMENT

### Patent Publication

[Patent publication 1] Japan Patent Publication No. 5-191992

### SUMMARY OF THE PRESENT DISCLOSURE

### Problems to be Solved by the Present Disclosure

Herein, it is assumed that, upon receiving a stop instruction, a driving circuit immediately turns off all arms of a bridge circuit connected to a fan motor. If a coil current flows in the fan motor at this point, the coil current returns to a power supply side, and a power voltage rises suddenly. The sudden rise in the power voltage may undesirably affect the reliability of the bridge circuit or circuit components of other circuits. Moreover, it is also possible that malfunction of overvoltage protection be incurred due to the sudden rise in the power voltage.

In addition, the same issue is not limited to taking place in a fan motor and may occur in all kinds of purposes of use.

In view of the issue above, the present disclosure provides a motor driving circuit capable of stopping operation within a short period of time.

### Technical Means for Solving the Problem

According to an aspect of the present disclosure, a driving circuit of a three-phase direct-current (DC) motor is provided. The driving circuit includes a control logic circuit for controlling a bridge circuit connected to the three-phase DC motor. The control logic circuit, in response to a stop instruction, fixes an upper arm of a source phase in which a current flows out to be off in the bridge circuit, and maintains statuses of other upper arms and lower arms, and then fixes the upper arms and the lower arms of all phases of the bridge circuit to be off.

According to another aspect of the present disclosure, a driving circuit of a three-phase DC motor is further provided. The driving circuit includes a control logic circuit for controlling a bridge circuit connected to the three-phase DC motor. The control logic circuit, in response to a stop instruction, fixes a lower arm of a sink phase in which a current flows in to be off in the bridge circuit, and then fixes the upper arms and the lower arms of all phases of the bridge circuit to be off.

Moreover, any combination of the constituent elements above, or mutual replacements or substitutions of the constituent elements or expressions among the method, device or system of the present disclosure are to be considered as effective implementation forms of the present disclosure.

### Effects of the Present Disclosure

According to an aspect of the present disclosure, a motor driving circuit of capable of stopping operation within a short period of time is provided.

### BRIEF DESCRIPTION OF THE DRAWINGS

FIG. 1 is a circuit diagram of a cooling device including a driving circuit of an embodiment.

FIG. 2 is a waveform diagram of outputs of three phases and a coil current of a driving circuit under 180-degree energization.

FIG. 3A and FIG. 3B are diagrams of current paths of a bridge circuit.

FIG. 4A to FIG. 4C are circuit diagrams for illustrating a first stop sequence.

FIG. 5 is a waveform diagram for illustrating a first stop sequence under a 120-degree energization control.

FIG. 6 is a waveform diagram for illustrating a first stop sequence under a 150-degree energization control.

FIG. 7A to FIG. 7C are circuit diagrams for illustrating a second stop sequence.

FIG. 8 is a waveform diagram for illustrating a second stop sequence under a 120-degree energization control.

FIG. 9 is a waveform diagram for illustrating a second stop sequence under a 150-degree energization control.

FIG. 10A to FIG. 10C are circuit diagrams for illustrating a third stop sequence.

FIG. 11 is a waveform diagram of a two-phase modulation (down manner) under a 180-degree energization control.

FIG. 12A to FIG. 12C are circuit diagrams for illustrating a fourth stop sequence.

FIG. 13 is a waveform diagram of a two-phase modulation (up and down manner) under a 180-degree energization control.

FIG. 14A to FIG. 14C are circuit diagrams for illustrating a fifth stop sequence.

FIG. 15 is a waveform diagram of a two-phase modulation (up and down manner) under a 180-degree energization control.

FIG. 16 is a three-dimensional diagram of a computer having a cooling device.

### DETAILED DESCRIPTION OF THE EMBODIMENTS

### Summary of Embodiments

A summary of several exemplary embodiments of the present disclosure are given below. The summary serves as the preamble of the detailed description to be given shortly and aims to provide fundamental understanding of the embodiments by describing several concepts of one or more embodiments in brief. It should be noted that the summary is not to be construed as limitation to the scope of the application or the present disclosure. Moreover, the summary is not a general summary of all possible and conceivable embodiments and does not define critical constituent elements of the embodiments. For illustration purposes, it is possible that the term “an/one embodiment” be used to refer to one embodiment (implementation form or variation example) of a plurality of embodiments (implementation forms or variation examples).

According to an embodiment, a driving circuit of a three-phase DC motor includes a control logic circuit for controlling a bridge circuit connected to the three-phase DC motor. The control logic circuit, in response to a stop instruction, fixes an upper arm of a source phase in which a current flows out to be off in the bridge circuit, and maintains statuses of other upper arms and lower arms, and then fixes the upper arms and the lower arms of all phases of the bridge circuit to be off.

According to the configuration, by fixing the upper arm of the source phase in which a current flows out to be off in the bridge circuit, a loop including multiple lower arms a motor coil is formed. In addition, by making the coil current flow in the loop, the coil current can be reduced within a short period of time. Further, by turning off all the arms when the coil current becomes sufficiently small, a sudden rise in a power voltage can be prevented.

In one embodiment, by controlling the three-phase DC motor by a control of wide-angle energization by the control logic circuit, a predetermined width, starting from a switching of a sink phase in which the current flows in, can be defined as a first prohibition interval in the bridge circuit. When the control logic circuit detects the stop instruction during the first prohibition interval under the control of wide-angle energization, the control logic circuit can wait for an end of the first prohibition interval and fix the upper arm of the source phase in which the current flows out to be off in the bridge circuit. By avoiding the first prohibition interval, the coil current can be prevented from flowing into a power line through a body diode (a return diode) of the upper arm.

In one embodiment, when the control logic circuit detects the stop instruction during the first prohibition interval under the control of wide-angle energization, the control logic circuit can fix a lower arm of a sink phase in which the current flows in to be off in the bridge circuit, and then fix the upper arms and the lower arms of all phases of the bridge circuit to be off. By fixing the lower arms of the sink phase of the bridge circuit to be off, a loop including multiple upper arms and a motor coil is formed. In addition, by making the coil current flow in the loop, the coil current can be reduced within a short period of time. Further, by turning off all the arms when the coil current becomes sufficiently small, a sudden rise in a power voltage can be prevented. In this case, a benefit of not needing to wait for the first prohibition interval to end is provided. In the description of the application, the term “wide-angle energization” refers to a control of an energization angle of 120° or more and less than 180°; in addition to 120-degree rectangular wave control, 135-degree energization control and 150-degree energization control and other arbitrary energization angle control are included.

In one embodiment, the control logic circuit is capable of controlling a three-phase DC motor by a two-phase modulation (down manner) of a 180-degree energization control, and a period can be defined as a first permission interval when the number of source phases is two. The control logic circuit can wait until the next first permission interval and fix the upper arms and lower arms of the two source phases to be off when the stop instruction is detected outside the first permission interval during operation under the two-phase modulation (down manner).

The first permission interval has a predetermined width that includes a timing at which output voltages of the two phases outputting a non-low voltage intersect. By defining the first permission interval using a timing at which output voltages of the two phases intersect as a center, the possibility that the number of source phases becomes one in the first permission interval can be reduced.

In one embodiment, the control logic circuit is capable of controlling the three-phase DC motor by a two-phase modulation (up and down manner) of a 180-degree energization control, and a period can be defined as a second permission interval when a number of source phases is two. The control logic circuit can wait until the next second permission interval and fix the upper arms and lower arms of the two source phases in which the current flows out to be off in the bridge circuit when the stop instruction is detected outside the second permission interval during operation under the two-phase modulation (up and down manner).

The second permission interval has a predetermined width that includes a timing at which output voltages of the two phases outputting a non-low voltage intersect. By defining the second permission interval using a timing at which output voltages of the two phases intersect as a center, the possibility that the number of source phases becomes one in the second permission interval can be reduced.

According to an embodiment, a driving circuit of a three-phase DC motor includes a control logic circuit for controlling a bridge circuit connected to the three-phase DC motor. The control logic circuit, in response to a stop instruction, fixes a lower arm of a sink phase in which a current flows in to be off in the bridge circuit, and then fixes the upper arms and the lower arms of all phases of the bridge circuit to be off.

In the configuration above, by fixing the lower arm of the source phase in which the current flows in to be off in the bridge circuit, a loop including multiple upper arms and a motor coil is formed. In addition, by making the coil current flow in the loop, the coil current can be reduced within a short period of time. Further, by turning off all the arms when the coil current becomes sufficiently small, a sudden rise in a power voltage can be prevented.

In one embodiment, by controlling the three-phase DC motor by a control of wide-angle energization by the control logic circuit, a predetermined width, starting from a switching of the upper arm of the source phase in which the current flows out, can be defined as a second prohibition interval in the bridge circuit. When the control logic circuit detects the stop instruction during the second prohibition interval under the control of wide-angle energization, the control logic circuit can wait for an end of the second prohibition interval and fix the lower arm of the sink phase to be off.

By avoiding the second prohibition interval, the coil current can be prevented from flowing into a power line through a body diode (a return diode) of the lower arm.

In one embodiment, the control logic circuit is capable of controlling the three-phase DC motor by a two-phase modulation (up and down manner) of a 180-degree energization control, and a period can be defined as a third permission interval when a number of sink phases is two. Further, the control logic circuit can wait until the next third permission interval and fix the upper arms and the lower arm of the two phases in which the current flows in to be off in the bridge circuit when the stop instruction is detected outside the third permission interval during operation under the two-phase modulation (up and down manner).

In one embodiment, the third permission interval has a predetermined width that includes a timing at which output voltages of the two phases outputting a non-high voltage intersect. By defining the third permission interval using a timing at which output voltages of the two phases intersect as a center, the possibility of a current flowing out in the two phases of outputting a non-low voltage can be reduced.

In one embodiment, the driving circuit may further include a bridge circuit.

In one embodiment, the driving circuit may be integrated on a semiconductor substrate. The term “integrated” includes a situation where all constituent elements of a circuit are formed on a semiconductor substrate, and a situation where main constituent elements of a circuit are integrated. Alternatively, some resistors or capacitors may be arranged outside the semiconductor substrate in order to adjust circuit constants. By integrating a circuit on a chip, the circuit area is reduced, and characteristics of circuit elements may be kept uniform.

### DETAILED DESCRIPTION

Appropriate embodiments are described with reference to the accompanying drawings below. The same or equivalent elements, components or processes shown in the drawings are assigned with the same denotations, and repeated description is appropriately omitted. Moreover, the embodiments are examples and are not to be construed as limitations to the present disclosure, and it should be noted that all the features and combinations thereof described in the embodiments are not necessarily essentials of the present disclosure.

In the description of the application, an expression “a state of component A connected to component B” includes, in addition to a situation where component A and component B are physically directly connected, a situation where component A is indirectly connected to component B via another component, without the another component resulting in substantial influences on the electrical connection state of component A and component B, or without impairing functions or effects exerted by the connection.

Similarly, an expression “a state of component C disposed between component A and component B” includes, in addition to a situation where component A and component C or component B and component C are physically directly connected, a situation of an indirect connection via another component, without the another component resulting in substantial influences on the electrical connection state of component A and component C or the component B and component C, or without impairing functions or effects exerted by the connection.

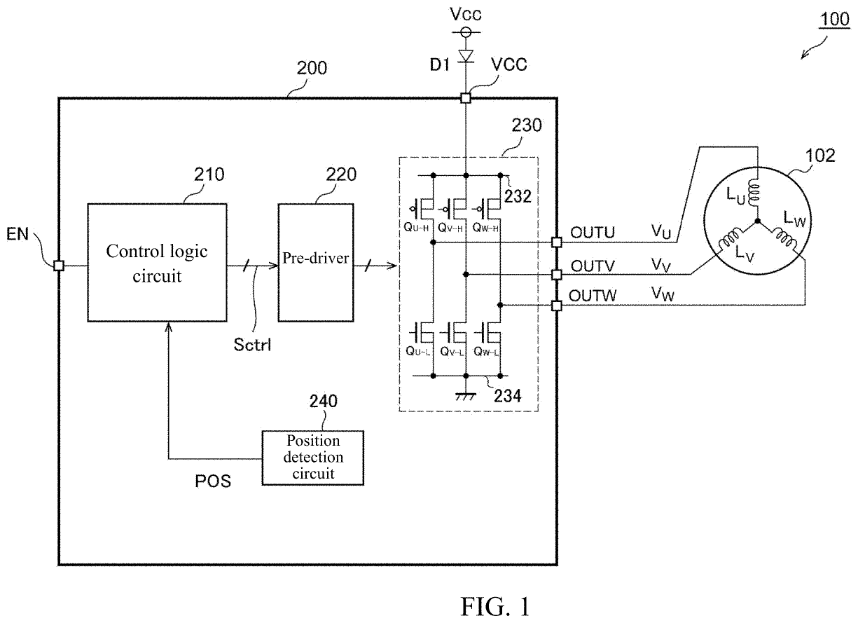

FIG. 1 shows a circuit diagram of a cooling device 100 including a driving circuit 200 of an embodiment. The cooling device 100 includes a fan motor 102 and the driving circuit 200. The fan motor 102 is a three-phase brushless DC motor, and includes a U-phase coil L_{U}, a V-phase coil L_{V} and W-phase coil L_{W}. The driving circuit 200 drives the fan motor 102 according to driving signals V_{U} to V_{W} supplied to the coils L_{U} to L_{W} of the fan motor 102.

The driving circuit 200 is integrated on an integrated circuit (IC), and includes a logic control circuit 210, a pre-driver 220, a bridge circuit 230 and a position detection circuit 240. The driving circuit 200 includes an enable terminal EN, and switches between operation and stop according to a signal supplied to the enable terminal EN.

A three-phase inverter, as a driving target of the bridge circuit 230, includes a U-phase leg, a V-phase leg and a W-phase leg, wherein the #-phase (where #=U, V and W) includes an upper arm Q_{#-H} and a lower arm Q_{#-L}. Each of the upper arm and the lower arm includes a switching element such as a metal oxide semiconductor field effect transistor (MOSFET), an insulated gate bipolar transistor (IGBT), or a bipolar transistor, and a return diode (also referred to as a flyback diode) connected in parallel to the switching element As shown in FIG. 1, when the MOSFET is used as the switching element, a body diode thereof (not shown) becomes the return diode.

A power line 232 of the bridge circuit 230 is connected to a power terminal (power pin) VCC and is supplied with a power voltage from the outside. Moreover, a ground line 234 of the bridge circuit 230 is grounded. A power voltage V_{CC} may be supplied to the power pin VCC via a diode D1 for reverse polarity protection.

The position detection circuit 240 detects a position of a rotor of the fan motor 102. For example, the position detection circuit 240 may be a back electromotive force (EMF) detection circuit and detects the position of the rotor based on a back EMF generated at a coil end of the fan motor 102. Alternatively, the position detection circuit 240 may also be a Hall detection circuit and detects the position of the rotor based on outputs of a Hall element mounted or embedded in the fan motor 102. The position detection circuit 240 may be implemented by a commonly known technique and is not limited to a specific configuration or type. The position detection circuit 240 outputs a position detection signal POS indicating the position of the rotor.

The logic control circuit 210 controls the bridge circuit 230 connected to the three-phase DC motor according to the output POS of the position detection circuit 240. Specifically, when an enable signal input to the enable terminal EN indicates an enable state, a control signal Sctrl is generated to prompt the fan motor 102 to rotate. The control signal Sctrl may include six signals indicating on and off of upper arms Q_{U-H}, Q_{V-H} and Q_{W-H} and lower arms Q_{U-L}, Q_{V-L} and Q_{W-L}.

Although not shown in FIG. 1, the control logic circuit 240 may change a target rotating speed according to a rotating speed control signal from the outside or an output signal of a temperature detection element.

The control means or circuit configuration of the control logic circuit 210 is not specifically defined and may be implemented by commonly known techniques. Specifically, the control logic circuit 210 may control the fan motor 102 by a control of wide-angle energization with an energization angle of 120° or more and less than 180° (for example, 120°, 135° or 150°), or may control the fan motor 102 by a 180-degree energization control (or referred to as sine wave driving). The logic control circuit 210 may also perform the control of wide-angle energization (for example, a 120-degree energization control) at start-up of the fan motor 102 rotating at a lower rotating speed and perform a 180-degree energization control once the fan motor 102 has reached a stable rotating speed.

The pre-driver 220 drives the upper arms Q_{U-H}, Q_{V-H} and Q_{W-H} and lower arms Q_{U-L}, Q_{V-L} and Q_{W-L} of the bridge circuit 230 according to the control signal Sctrl generated by the control logic circuit 210.

In this embodiment, the control logic circuit 210 performs a characteristic stop sequence in response to a stop instruction for the driving circuit 200. The stop instruction typically corresponds to, for example but not limited to, a transition of the enable signal input to the enable terminal EN from high to low. Apart from the enable terminal EN, a terminal for inputting a stop signal may also be present.

Issues that may occur when the operation of the driving circuit 200 is stopped are described below.

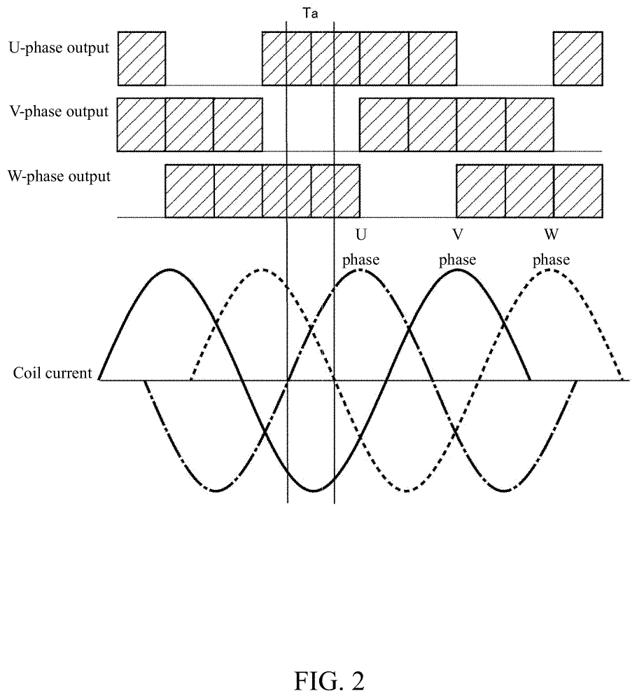

FIG. 2 shows a waveform diagram of outputs of three phases and a coil current of a driving circuit under 180-degree energization. The shading lines represent states of outputting high (non-zero) voltages. When a current flows out from the bridge circuit 230 (output, sink) into a coil of a phase, the coil current is positive; vice versa, when the current flows from the coil of a phase into the bridge circuit 230 (feed, source), the coil current is negative.

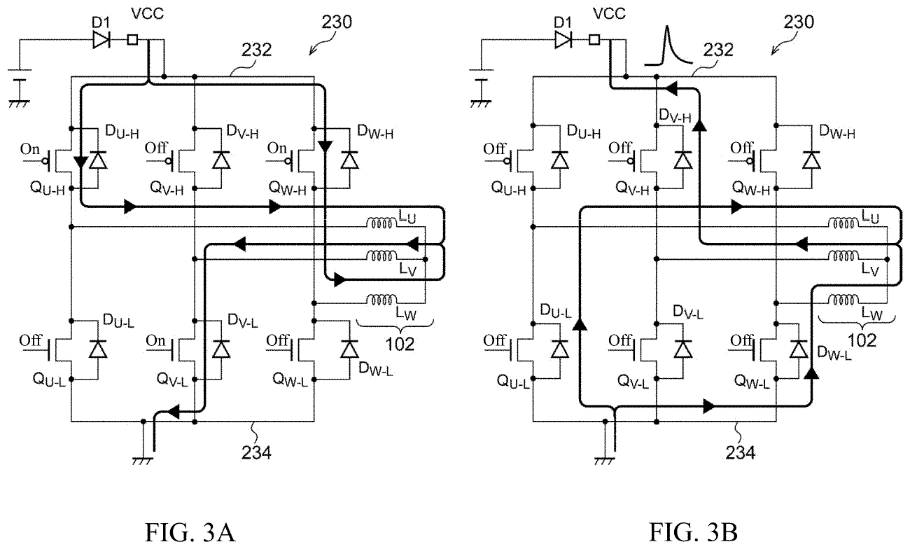

FIG. 3A and FIG. 3B shows diagrams of current paths of the bridge circuit 230. FIG. 3A shows statuses of the arms and the current path of the bridge circuit 230 in a time interval Ta in FIG. 2. In the status in FIG. 3A, the current flows from the power line through the U-phase and W-phase upper arms, the coil of the motor and the V-phase lower arm to the ground line.

FIG. 3B shows the current paths when all the arms are simultaneously set to be off from the status in FIG. 3A. In this status, the current flows from the ground line through the U-phase and W-phase body diodes, the coil of the motor and the V-phase body diode to the power line 232. As a result, the potential of the power line 232 rises drastically and suddenly.

Stop sequences capable of inhibiting the sudden rise in the power line 232 of the bridge circuit 230 are described below.

### (First Stop Sequence)

Upon detecting a stop instruction, the control logic circuit 210 fixes the upper arm of a source phase in which a current flows out to be off in the bridge circuit 230, and maintains statuses of other upper arms and lower arms (a first state ϕ₁₁). The control logic circuit 210 then fixes the upper arms and the lower arms of all phases of the bridge circuit 230 to be off (a second state ϕ₁₂).

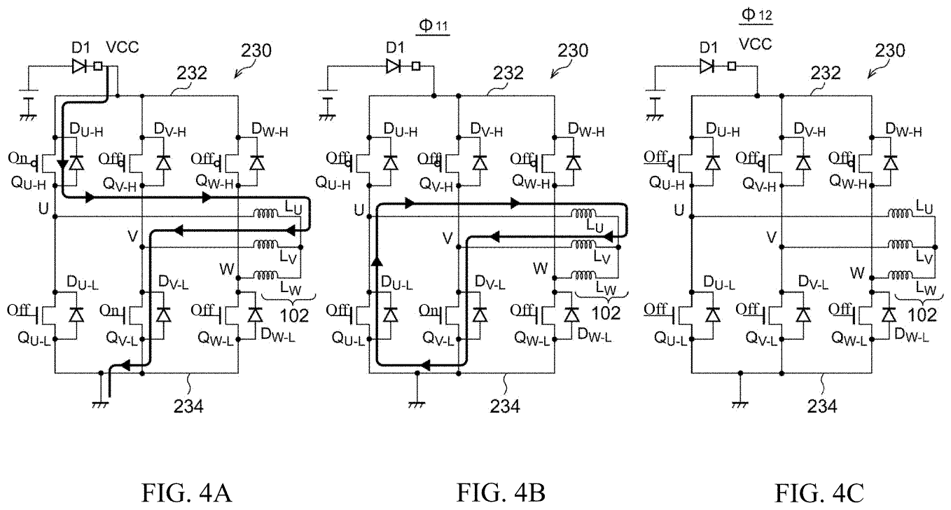

FIG. 4A to FIG. 4C show circuit diagrams for illustrating the first stop sequence. FIG. 4A shows a normal state of the bridge circuit 230 under the wide-angle energization control before the stop instruction. The U-phase upper arm Q_{U-H} and the V-phase lower arm Q_{V-L} are on, a positive coil current flows in the U-phase coil L_{U}, and a negative coil current flows in the V-phase coil L_{V}.

FIG. 4B shows the first state ϕ₁₁ of the bridge circuit 230 after having detected the stop instruction. Upon detecting the stop instruction (FIG. 4A), U phase becomes a source phase since the current flows out from the U-phase output of the bridge circuit 230. Thus, upon detecting the stop instruction, the control logic circuit 210 fixes the upper arm Q_{U-H} of the U phase as the source phase to be off. The control logic circuit 210 maintains the statuses of other upper arms and lower arms at the statuses of a previous moment (FIG. 4A).

In the first state ϕ₁₁ in FIG. 4B, a loop, starting from the ground line 234, including the body diode D_{U-L} of the U-phase lower arm Q_{U-L}, the U-phase coil L_{U}, the V-phase coil L_{V} and the V-phase lower arm Q_{V-L}, and returning to the ground line 234, is formed. By making the coil current flow in the loop, the coil current can be reduced within a short period of time. Typically, under a time scale equivalent to an electrical angle of 30° to 60° and at a maximum of 90°, the coil current substantially reduces to zero.

In the first state ϕ₁₁ in FIG. 4B, the bridge circuit 230 can switch to the second state ϕ₁₂ in FIG. 4C when the coil current becomes sufficiently small. In the second state ϕ₁₂, all the upper arms Q_{U-H}, Q_{V-H} and Q_{W-H} and all the lower arms Q_{U-L}, Q_{V-L} and Q_{W-L} are fixed to be off. The so-called “when the current is sufficiently small” means that even when the coil current flows into the power line 232, any level of rise in the voltage of the power line does not become an issue.

The control logic circuit 210 may also transition to the second state ϕ₁₂ after a specific time has elapsed from the migration to the first state ϕ₁₁. Alternatively, the control logic circuit 210 may also transition to the second state ϕ₁₂ after a time equivalent to a predetermined electrical angle has elapsed from the migration to the first state ϕ₁₁.

Alternatively, for example, the electrical angle may be set to 0°, 30°, 60°, 90°, . . . , 300°, 330° and 360°, and the transition is allowed at a step of every predetermined electrical angle width (30°). It is assumed that a minimum duration of the first state ϕ₁₁ is specified to be, for example, an electrical angle of 30°. In this case, when the stop instruction is received at a timing of 20°, transition to the first state ϕ₁₁ may be made immediately, and no transition to the second state ϕ₁₂ is made at a timing of 50° after 30° has elapsed, but such transition to the second state ϕ₁₂ is made at a next transition permission timing, that is, 60°.

Alternatively, when the stop instruction is received at the timing of 20°, transition to the first state ϕ₁₁ is made at the next transition permission timing, that is, 30°, and then transition to the second state ϕ₁₂ is made at the next transition permitted timing, that is, 60°.

Alternatively, if a detection circuit for a coil current is provided in the driving circuit 200, transition to the second state ϕ₁₂ may be made upon detecting that a current has reduced to a threshold near zero.

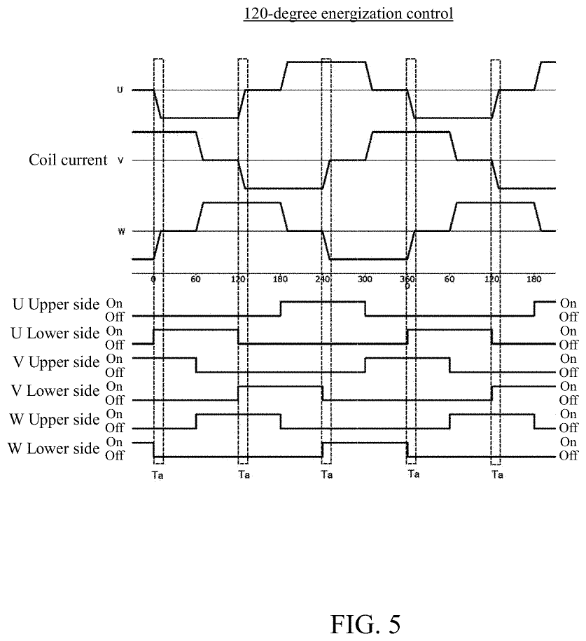

FIG. 5 shows a waveform diagram for illustrating a first stop sequence under a 120-degree energization control. A predetermined width starting from a switching of a sink phase in which the current flows in is depicted by dotted blocks.

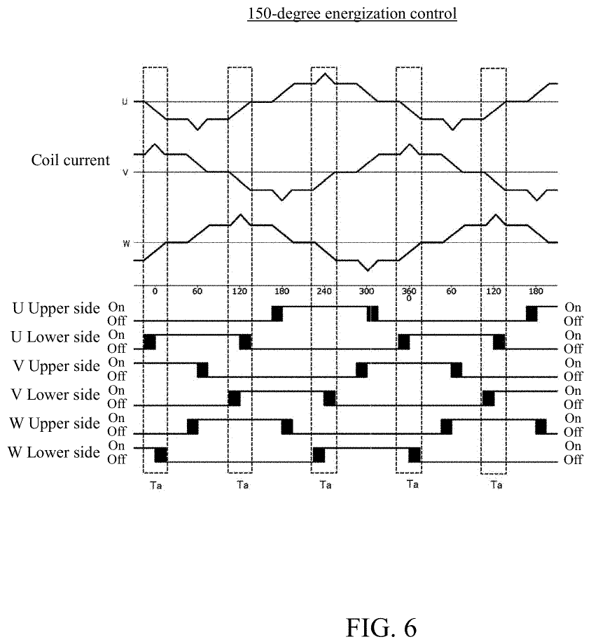

FIG. 6 shows a waveform diagram for illustrating a first stop sequence under a 150-degree energization control. Similar to FIG. 5, a predetermined width starting from a switching of a sink phase in which the current flows in, is depicted by dotted blocks.

In an interval within a dotted block in FIG. 5 or FIG. 6, the coil current flows into the power line if the upper arm is turned off according to the first stop sequence. Thus, in the first stop sequence, the range within the dotted block is specified as a first prohibition interval Ta.

When the control logic circuit 210 detects the stop instruction during the first prohibition interval Ta under the control of wide-angle energization control such as 120-degree energization control or 150-degree energization control, the control logic circuit 210 waits for an end of the first prohibition interval Ta, transitions to the first state ϕ₁₁, and fixes the upper arm of the source phase in which the current flows out to be off in the bridge circuit 230. By setting the first prohibition interval Ta, the coil current can be prevented from flowing into the power line.

Details of the first stop sequence are as described above. According to the stop sequence, the coil current can be reduced within a short period of time in the first state ϕ1, and transition to the second state ϕ₁₂ is made after the coil current reduces, thus preventing the current from flowing into the power line. After the transition to the second state ϕ₁₂, the driving circuit 200 is overall in a disabled state, hence significantly reducing power consumption.

It should be noted that the stop sequence is not to be confused with braking. Braking focuses on the control for stopping rotation of a rotor, while the coil current continues flowing in the coil. In comparison, the stop sequence of this embodiment focuses on the control for reducing the coil current, and if the coil current is reduced, the rotor can be kept idling in the second state ϕ₁₂. In the case where an operation start instruction is received immediately after receiving a stop instruction, a greater difference arises between braking and the stop sequence.

Upon receiving an operation start instruction (when the enable terminal is enabled), the driving circuit 200 starts rotation of the fan motor 102 according to a predetermined start sequence. In general, in a start sequence, it is first monitored whether the fan motor 102 is idling, and all of the arms of the bridge circuit 230 are set to be off at this point.

In the case where stop is due to braking, it is possible that the residual coil current is present at the time when an operation start instruction is received. At this point, if all the arms of the bridge circuit 230 are turned off in order to detect idling, there is a concern for a sudden rise in the voltage if the residual coil current flows into the power line.

In comparison, in the case where a stop sequence is performed, since all the arms are turned off, transition of the status of the bridge circuit 230 in order to detect idling is not needed. Moreover, because the coil current becomes extremely small, the concern for a sudden rise in the voltage is eliminated.

### (Second Stop Sequence)

Upon detecting a stop instruction, the control logic circuit 210 fixes the lower arm of a sink phase in which a current flows in to be off in the bridge circuit 230, and maintains statuses of other upper arms and lower arms (a first state ϕ21). The control logic circuit 210 then fixes the upper arms and the lower arms of all phases of the bridge circuit 230 to be off (a second state ϕ₂₂).

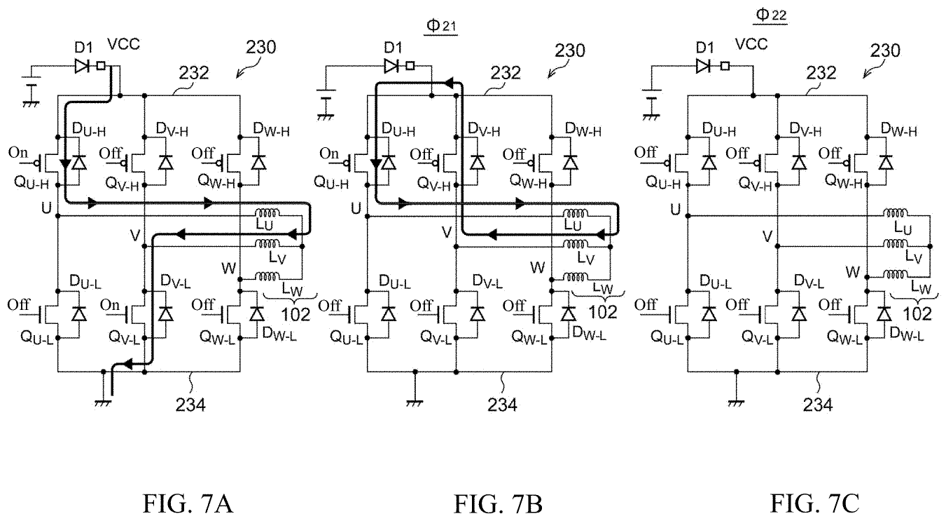

FIG. 7A to FIG. 7C show circuit diagrams for illustrating the second stop sequence. FIG. 7A shows a normal state of the bridge circuit 230 under the wide-angle energization control before the stop instruction. The U-phase upper arm Q_{U-H} and the V-phase lower arm Q_{V-L} are on, a positive coil current flows in the U-phase coil L_{U}, and a negative coil current flows in the V-phase coil L_{V}.

FIG. 7B shows the first state ϕ₂₁ of the bridge circuit 230 after having detected the stop instruction. Upon detecting the stop instruction (FIG. 7A), the U phase becomes a sink phase since the current flows out from the V-phase output in the bridge circuit 230. Thus, upon detecting the stop instruction, the control logic circuit 210 fixes the lower arm Q_{V-L} of the V phase as the sink phase to be off. The control logic circuit 210 maintains the statuses of other upper arms and lower arms at the statuses of a previous moment (FIG. 7A).

In the first state ϕ₂₁ in FIG. 7B, a loop, starting from the power line 232, including the U-phase upper arm, the U-phase coil L_{U}, the V-phase coil L_{V} and the body diode D_{V-H} of the upper arm Q_{V-H} of the V phase, and returning to the power line 232, is formed. By making the coil current flow in the loop, the coil current can be reduced within a short period of time. Typically, under a time scale approximately equivalent to an electrical angle of 30° to 60° and at a maximum of 90°, the coil current substantially reduces to zero.

In the first state ϕ₂₁ in FIG. 7B, the bridge circuit 230 can switch to the second state ϕ₂₂ in FIG. 7C when the coil current becomes sufficiently small. In the second state ϕ₂₂, all the upper arms Q_{U-H}, Q_{V-H} and Q_{W-H} and all the lower arms Q_{U-L}, Q_{V-L} and Q_{W-L} are fixed to be off.

In the second stop sequence, methods for switching from the first state ϕ₂₁ to the second state ϕ₂₂ are the same as methods given in the description with respect to the first stop sequence.

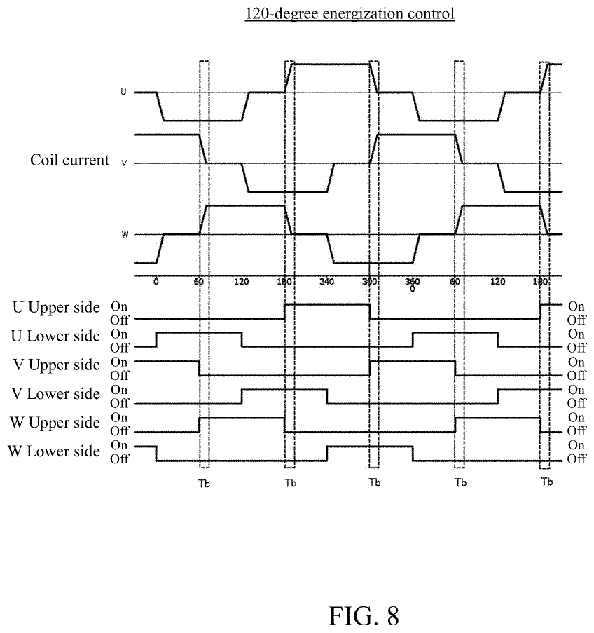

FIG. 8 shows a waveform diagram for illustrating the second stop sequence under a 120-degree energization control. A predetermined width starting from a switching of a source phase in which the current flows out is depicted by dotted blocks.

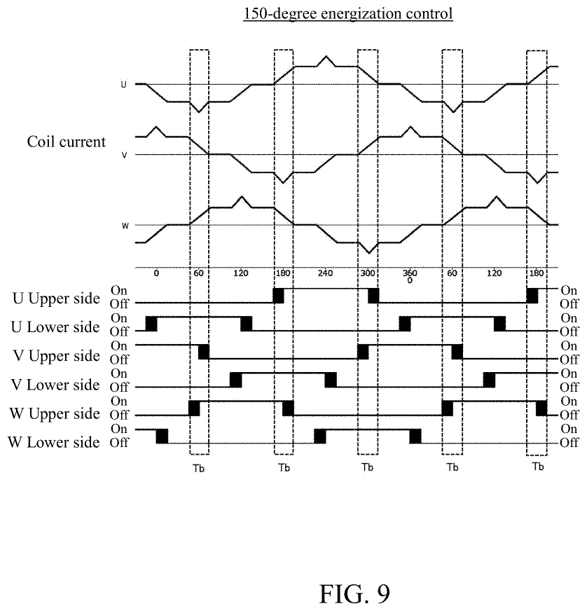

FIG. 9 shows a waveform diagram for illustrating the second stop sequence under a 150-degree energization control. A predetermined width starting from a switching of a source phase in which the current flows out is depicted by dotted blocks.

In an interval within a dotted block in FIG. 8 or FIG. 9, the coil current flows into the power line if the lower arm is turned off according to the second stop sequence. Thus, in the second stop sequence, the range within the dotted block is specified as a second prohibition interval Tb.

When the control logic circuit 210 detects the stop instruction during the second prohibition interval Tb under the control of wide-angle energization control such as a 120-degree energization control or 150-degree energization control, the control logic circuit 210 waits for an end of the second prohibition interval Tb, transitions to the first state ϕ₂₁, and fixes the lower arm of the sink phase in which the current flows in to be off in the bridge circuit 230. By setting the second prohibition interval Tb, the coil current can be prevented from flowing into the power line.

### (Combination of First Stop Sequence and Second Stop Sequence)

The first stop sequence and the second stop sequence can be used in combination. For example, the first stop sequence can be the main and second stop sequence can be the secondary. In this case, the first stop sequence may be implemented when the stop instruction is detected outside the first prohibition interval Ta, and the second stop sequence may be implemented when the stop instruction is detected within the first prohibition interval Ta.

Conversely, the second stop sequence can be the main and first stop sequence can be the secondary. In this case, the second stop sequence may be implemented when the stop instruction is detected outside the second prohibition interval Tb, and the first stop sequence may be implemented when the stop instruction is detected within the second prohibition interval Tb.

With the combination of the two stop sequences, transition to the first state ϕ₁₁ or the first state ϕ₂₁ can be made without having to wait for the end of the prohibition interval.

### (Third Stop Sequence)

The control logic circuit 210 is capable of controlling a three-phase DC motor by a two-phase modulation (down manner) of a 180-degree energization control. In the third stop sequence, similar to the first sequence, the state of the source phase is first switched.

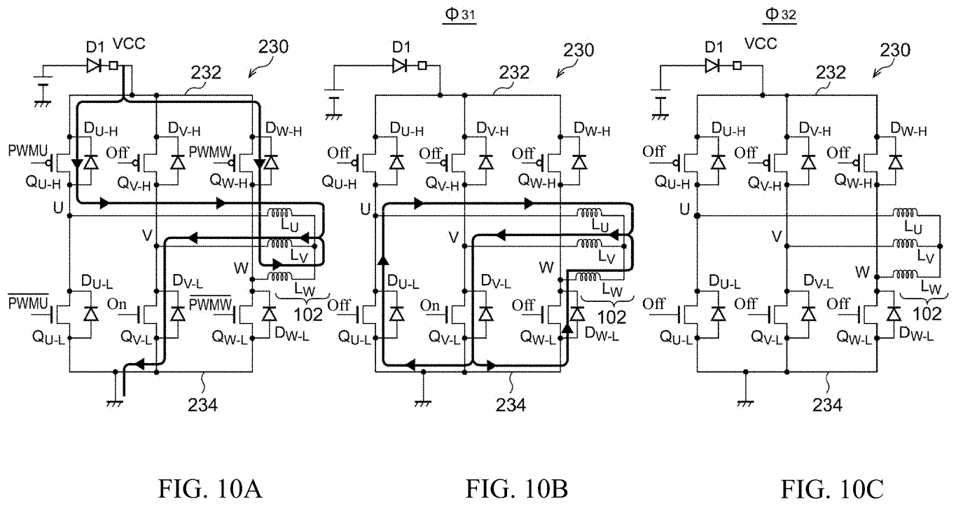

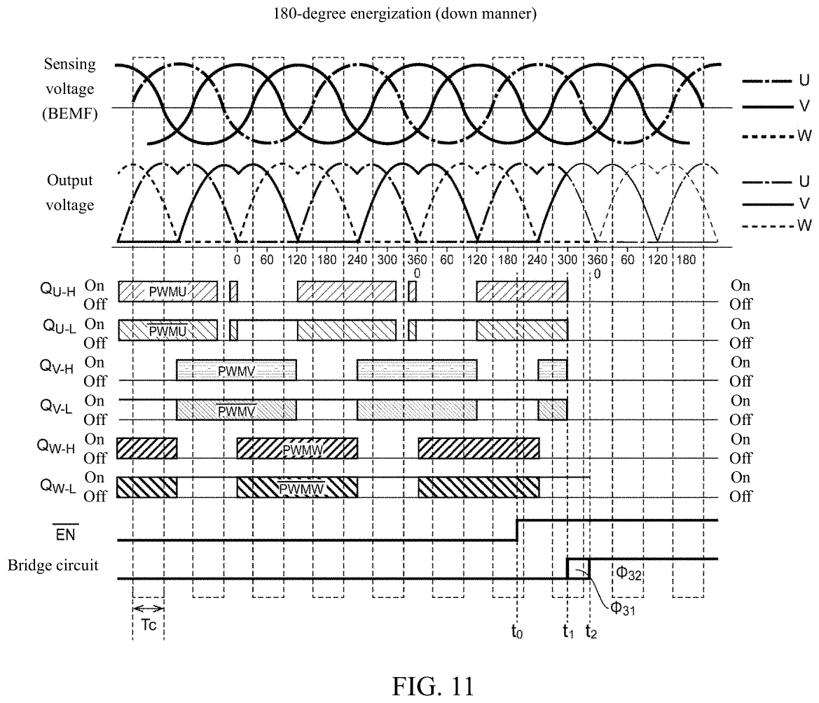

FIG. 10A to FIG. 10C show circuit diagrams for illustrating the third stop sequence. FIG. 10A shows a normal state of the bridge circuit 230 during the operation by the 180-degree energization control (sine wave driving) before the stop instruction. In the two-phase modulation (down manner), one of the three phases of the bridge circuit 230 outputs a low voltage (0 V), and the remaining two phases output a non-low voltage. Pulse width modulation (PWM) control is performed on the upper arms and lower arms of the phases outputting a non-low voltage such that the arms switch complementarily, so as to obtain an equivalent output voltage shown in FIG. 11.

In FIG. 10A, the V phase outputs a low voltage, and the U phase and the W phase output a non-low voltage under the PWM control. Moreover, a positive coil current flows in the U-phase coil L_{U} and the W-phase coil L_{W}, and a negative coil current flows in the V-phase coil L_{V}.

FIG. 10B shows the first state ϕ31 of the bridge circuit 230 after having detected the stop instruction. Upon detecting the stop instruction (FIG. 10A), the U phase and the W phase becomes sources phases since the current flows out from the U-phase output and the W-phase output of the bridge circuit 230, and the number of the source phases is two. Upon detecting the stop instruction, the control logic circuit 210 fixes the upper arms Q_{U-H} and Q_{W-H} of the U phase and the W phase as the source phases to be off, and also fixes the lower arms Q_{U-L} and Q_{W-L} to be off. That is, outputs of the U phase and the W phase become high impedances. The control logic circuit 210 maintains the remaining one phase, that is, the V phase, to an output state of a previous moment (FIG. 10A), that is, a low output (the upper arm Q_{V-H} is off and the lower arm Q_{V-L} is on).

In a first state ϕ₃₁ in FIG. 10B, a lower loop, starting from the ground line 234 and through the transistor of the lower arm or the body diode of the lower arm, is formed. By making the coil current flow in the loop, the coil current can be reduced within a short period of time.

In the first state ϕ₃₁ in FIG. 10B, the bridge circuit 230 can switch to the second state ϕ32 in FIG. 10C when the coil current becomes sufficiently small. In the second state ϕ32, all the upper arms Q_{U-H}, Q_{V-H} and Q_{W-H} and all the lower arms Q_{U-L}, Q_{V-L} and Q_{W-L} are fixed to be off.

In the third stop sequence, methods for switching from the first state ϕ₃₁ to a second state ϕ₃₂ are the same as methods given in the description with respect to the first stop sequence.

FIG. 11 shows a waveform diagram of a two-phase modulation (down manner) under a 180-degree energization control. In FIG. 11, the coil current, the equivalent output voltage, statuses of the upper and lower arms of the respective phases, the stop indication (EN\) and the status of the bridge circuit are depicted from top to bottom. The dotted blocks indicate a period in which a current flows out from two phases, that is, a period in which the number of source phases is two. The number of sources phases is one outside these periods.

In the third stop sequence, if the bridge circuit 230 is switched to the first state ϕ₃₁ in an interval (outside the dotted lines) when the number of sources phases is one, no loop is formed, and the current flows into the power line. Thus, in the third stop sequence, a first permission interval Tc is specified to be within areas inside the dotted blocks. If the first permission interval Tc is specified to be coincident with the dotted lines, even if a timing is slightly shifted forward or backward, the number of the source phases within the first permission interval Tc also changes to one. That is to say, although the first permission interval Tc may be completely coincident with the dotted lines, it is ideally narrower than the dotted lines.

For example, the first permission interval Tc may be a predetermined width that includes a timing (for example, an electrical angle of 60°, 180° or 300°) at which output voltages of the two phases outputting a non-low voltage intersect, hence specifying the predetermined width to be narrower than 60°. By defining the first permission interval Tc using a timing at which output voltages of the two phases intersect as a center, the possibility that the number of source phases becomes one in the first permission interval Tc can be reduced.

The description above is given on the basis of a two-phase output voltage, and an interval in which the number of the source phases indirectly detected is two; however, the present disclosure is not limited to the example above. Further, a coil current for three phases may also be monitored, and an interval in which the number of sources phase is directly detected may be two. Currents of three phases may be individually detected, a sum of the currents of the three phases may be zero, and only the currents of two of the phases are detected so as to calculate the current of the one remaining phase.

As shown in FIG. 11, the control logic circuit 210 can wait until a timing ti included in the next first permission interval Tc and fix the upper arms and lower arms of the two source phases outputting a non-low voltage to be off when the stop instruction is detected outside the first permission interval Tc at a timing to during operation under the two-phase modulation (up and down manner).

### (Fourth Stop Sequence)

The control logic circuit 210 is capable of controlling a three-phase DC motor by a two-phase modulation (up and down manner) of a 180-degree energization control. In the two-phase modulation (up and down manner), one phase of the outputs of the three phases of the bridge circuit 230 may output a low voltage (0 V), and the remaining two phases may output non-low voltage; alternatively, one phase of the outputs of the three phases may output a high voltage (V_{CC}), and the remaining two phases may output a non-high voltage. In the fourth stop sequence, similar to the third stop sequence, the statuses of the two source phases are first switched during a period in which one phase outputs a low voltage.

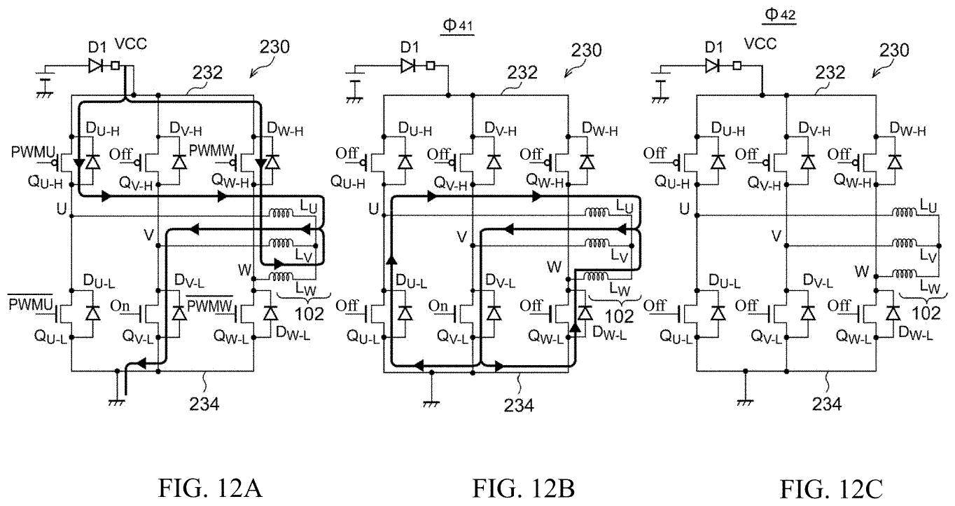

FIG. 12A to FIG. 12C show circuit diagrams for illustrating the fourth stop sequence. FIG. 12A shows a normal state of the bridge circuit 230 during the operation by the 180-degree energization control (sine wave driving) before the stop instruction.

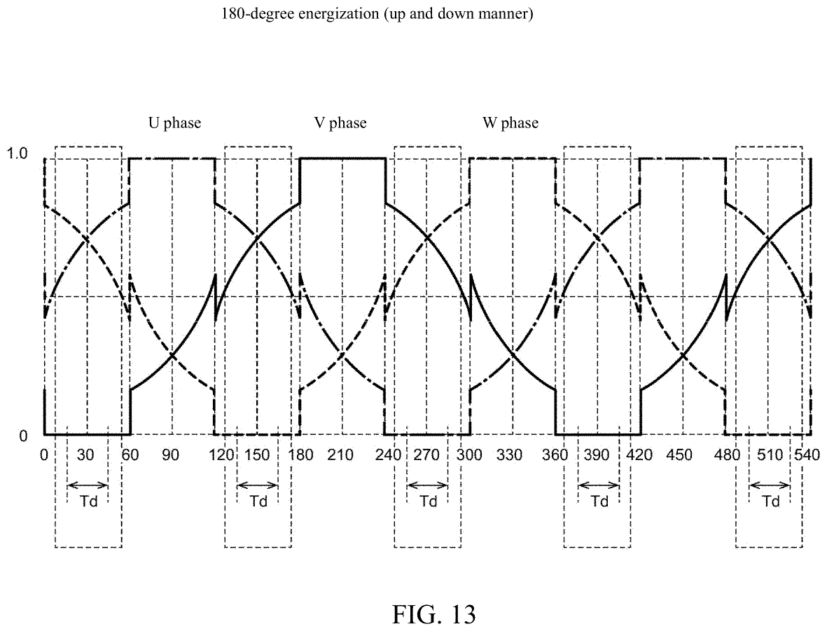

In FIG. 12A, the V phase outputs a low voltage. PWM control is performed on the upper arm and lower arm of the U phase and the W phase outputting a non-low voltage such that the arms switch complementarily, so as to obtain an equivalent output voltage shown in FIG. 13. Moreover, a positive coil current flows in the U-phase coil L_{U} and the W-phase coil L_{W}, and a negative coil current flows in the V-phase coil L_{V}.

FIG. 12B shows the first state ϕ41 of the bridge circuit 230 after having detected the stop instruction. Upon detecting the stop instruction (FIG. 12A), the U phase and the W phase become sources phases since the current flows out from the U-phase output and the W-phase output of the bridge circuit 230, and the number of the source phases is two. Upon detecting the stop instruction, the control logic circuit 210 fixes the upper arms Q_{U-H} and Q_{W-H} of the U phase and the W phase as the source phases to be off, and also fixes the lower arms Q_{U-L} and Q_{W-L} to be off. That is, outputs of the U phase and the W phase become high impedances. The control logic circuit 210 maintains the remaining one phase, that is, the V phase, to an output state of a previous moment (FIG. 12A), that is, a low output (the upper arm Q_{V-H} is off and the lower arm Q_{V-L} is on).

In the first state ϕ41 in FIG. 12B, a loop of a lower side, starting from the ground line 234 and through the transistor of the lower arm or the body diode of the lower arm, is formed. By making the coil current flow in the loop, the coil current can be reduced within a short period of time.

In the first state ϕ₄₁ in FIG. 12B, the bridge circuit 230 can switch to the second state ϕ42 in FIG. 12C when the coil current becomes sufficiently small. In the second state ϕ₄₂, all the upper arms Q_{U-H}, Q_{V-H} and Q_{W-H} and all the lower arms Q_{U-L}, Q_{V-L} and Q_{W-L} are fixed to be off.

In the fourth stop sequence, methods for switching from the first state ϕ₄₁ to a second state ϕ₄₂ are the same as methods given in the description with respect to the first stop sequence.

FIG. 13 shows a waveform diagram of a two-phase modulation (up and down manner) under a 180-degree energization control. The dotted blocks indicate a period in which a current flows out from two phases, that is, a period in which the number of source phases is two. The number of sources phases is one outside these periods.

In the fourth stop sequence, if the bridge circuit 230 is switched to the first state ϕ₄₁ in an interval (outside the dotted lines) when the number of sources phases is one, no loop is formed, and the current flows into the power line. Thus, in the fourth stop sequence, a second permission interval Td is specified to be within areas outside the dotted blocks. If the second permission interval Td is specified to be coincident with the dotted lines, even if a timing is slightly shifted forward or backward, the number of the source phases within the second permission interval Td also changes to one. That is to say, although the second permission interval Td may be completely coincident with the dotted lines, it is ideally narrower than the dotted lines.

For example, the second permission interval Td may be a predetermined width that includes a timing (in this example, an electrical angle of 30°, 150° or 270°) at which output voltages of the two phases outputting a non-low voltage intersect, hence specifying the predetermined width to be narrower than 60°. By defining the second permission interval Td using a timing at which output voltages of the two phases intersect as a center, the possibility that the number of source phases becomes one in the second permission interval Td can be reduced.

The control logic circuit 210 can wait until the next second permission interval Td and fix the upper arms and lower arms of the two source phases of the bridge circuit 230 to be off when the stop instruction is detected outside the second permission interval Td during operation under the two-phase modulation (up and down manner).

### (Fifth Stop Sequence)

Similar to the fourth stop sequence, the control logic circuit 210 is capable of controlling a three-phase DC motor by a two-phase modulation (up and down manner) of a 180-degree energization control. In the fifth stop sequence, quite contrary to the fourth stop sequence, the statuses of the two sink phases are first switched during a period in which one phase outputs a high voltage.

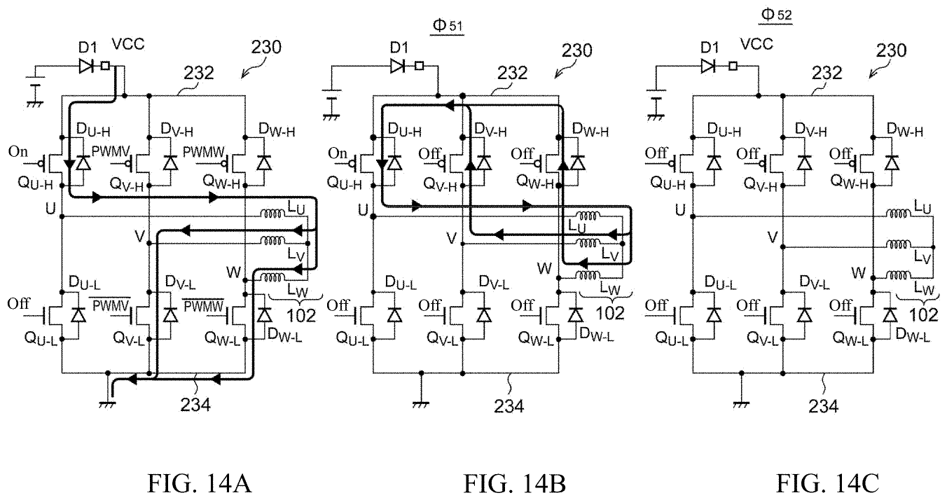

FIG. 14A to FIG. 14C shows circuit diagrams for illustrating the fifth stop sequence. FIG. 14A shows a normal state of the bridge circuit 230 during the operation by the 180-degree energization control (sine wave driving) before the stop instruction.

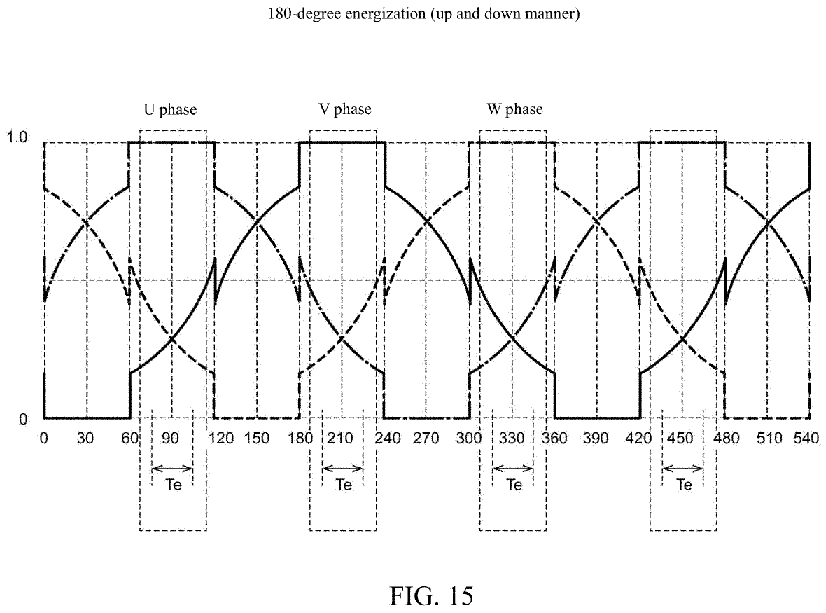

In FIG. 14A, the U phase outputs a high voltage. PWM control is performed on the upper arms and lower arms of the V phase and the W phase outputting a non-low voltage such that the arms switch complementarily, so as to obtain an equivalent output voltage shown in FIG. 15. Moreover, a positive coil current flows in the U-phase coil L_{U}, and a negative coil current flows in the V-phase coil L_{V} and W-phase coil L_{W}.

FIG. 14B shows the first state ϕsi of the bridge circuit 230 after having detected the stop instruction. Upon detecting the stop instruction (FIG. 14A), the V phase and the W phase become sink phases since the current flows in the V-phase output and the W-phase output of the bridge circuit 230, and the number of the sink phases is two. Upon detecting the stop instruction, the control logic circuit 210 fixes the upper arms Q_{V-H} and Q_{W-H} of the V phase and the W phase as the sink phases to be off, and also fixes the lower arms Q_{V-L} and Q_{W-L} to be off. That is, outputs of the V phase and the W phase become high impedances. The control logic circuit 210 maintains the remaining one phase, that is, the U phase, to an output state of a previous moment (FIG. 14A), that is, a high output (the upper arm Q_{U-H} is on and the lower arm Q_{U-L} is off).

In the first state ϕsi in FIG. 14B, a loop, starting from the ground line 232 and through the transistor of the upper arm and the body diode at the side of the upper arm, is formed. By making the coil current flow in the loop, the coil current can be reduced within a short period of time.

In the first state ϕsi in FIG. 14B, the bridge circuit 230 can switch to the second state ϕ₅₂ in FIG. 14C when the coil current becomes sufficiently small. In the second state $52, all the upper arms Q_{U-H}, Q_{V-H} and Q_{W-H} and all the lower arms Q_{U-L}, Q_{V-L} and Q_{W-L} are fixed to be off.

In the fifth stop sequence, methods for transitioning from the first state ϕ₅₁ to a second state ϕ₅₂ are the same as methods given in the description with respect to the first stop sequence.

FIG. 15 shows a waveform diagram of a two-phase modulation (up and down manner) under a 180-degree energization control. The dotted blocks indicate a period in which a current flows in from two phases, that is, a period in which the number of sink phases is two. The number of sink phases is one outside these periods.

In the fifth stop sequence, if the bridge circuit 230 is switched to the first state ϕ51 in an interval (outside the dotted lines) when the number of sink phases is one, no loop is formed, and the current flows into the power line. Thus, in the fifth stop sequence, a third permission interval Te is specified to be within areas inside the dotted blocks. If the third permission interval Te is specified to be coincident with the dotted lines, even if a timing is slightly shifted forward or backward, the number of the sink phases within the second permission interval Te changes to one. That is to say, although the third permission interval Te may be completely coincident with the dotted lines, it is ideally narrower than the dotted lines.

For example, the third permission interval Te may be a predetermined width that includes a timing at which output voltages of the two phases outputting a non-high voltage intersect, hence specifying the predetermined width to be narrower than 60°. By defining the third permission interval Te using a timing (in this example, an electrical angle of 90°, 210° or 330°) at which output voltages of the two phases intersect as a center, the possibility that the number of sink phases becomes one in the third permission interval Te can be reduced.

The control logic circuit 210 can wait until the next third permission interval Te and fix the upper arms and lower arms of the two sink phases of the bridge circuit 230 to be off when the stop instruction is detected outside the third permission interval Te during operation under the two-phase modulation (up and down manner).

### (Combination of Fourth Stop Sequence and Fifth Stop Sequence)

The fourth stop sequence and the fifth stop sequence may be implemented in combination. The fourth stop sequence may be implemented when the stop instruction is detected within the second prohibition interval Td, and the fifth stop sequence may be implemented when the stop instruction is detected within the third prohibition interval Te.

### (Variation Example)

The embodiments are described as above. It is understandable to a person skilled in the art that, the embodiments are examples, a combination of the constituent elements or processes above may include various variation examples, and these variation examples are to be encompassed within the scope of the present disclosure. One of such variation examples is described below.

In the embodiment, the control logic circuit 210, the pre-driver 220 and the bridge circuit 230 are, for example but not limited to, integrated on a semiconductor chip. For example, the bridge circuit 230 may also be formed by a discrete element. Alternatively, the control logic circuit 210 may also be an independent integrate circuit.

### (Use)

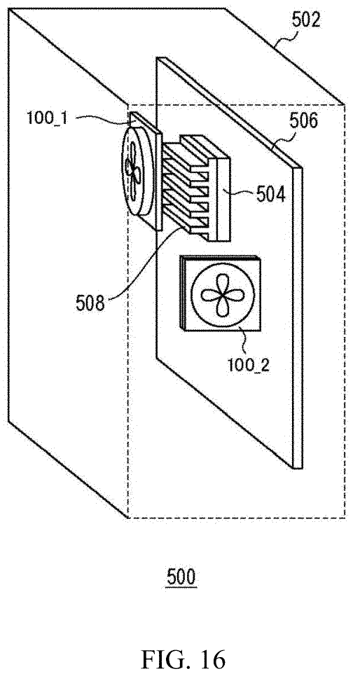

Lastly, the use of the driving circuit 200 is described below. FIG. 16 shows a three-dimensional diagram of a computer having the cooling device 100. The cooling device 100 includes the fan motor 102 and the driving circuit 200 shown in FIG. 1. The computer 500 includes a casing 502, a CPU 504, a motherboard 506, a heat sink 508, and a plurality of cooling devices 100_1 and 100_2.

The CPU 504 is mounted on the motherboard 506. The heat sink 508 is sealed and connected on an upper surface of the CPU 504. The cooling device 100_1 is arranged opposite to the heat sink 508, and blows air toward the heat sink 508. The cooling device 100_2 is arranged on a back surface of the casing 502, and draws air outside the casing 502 to the inside, or discharges internal air to the outside.

In the embodiment, the cooling device 100 is capable of starting the fan motor 102 within a short time, and can thus quickly cool a cooling target.

In addition to the computer 500 in FIG. 16, the cooling device 100 may also be mounted on various electronic machines such as workstations, laptop computers, television and refrigerators.

Moreover, the use of the driving circuit 200 of the embodiments is not limited to driving a fan motor and may be used to drive other types of motors.

The embodiments described in specific terms are for representing the principles and applications of the present disclosure, and modifications to the variation examples or configurations of the embodiments can be made without departing from the scope of the concept of the present disclosure accorded with the appended claims.

1. A driving circuit, which is a driving circuit of a three-phase DC motor, the driving circuit comprising:
a control logic circuit for controlling a bridge circuit connected to the three-phase DC motor, wherein
the control logic circuit, in response to a stop instruction, fixes an upper arm of a source phase in which a current flows out to be off in the bridge circuit, and maintains statuses of other upper arms and lower arms, and then
fixes the upper arms and the lower arms of all phases of the bridge circuit to be off.

2. The driving circuit of claim 1, wherein
the control logic circuit is capable of controlling the three-phase DC motor by a control of wide-angle energization,
in the bridge circuit, a predetermined width starting from a switching of a sink phase into which the current flows is defined as a first prohibition interval, and
when the control logic circuit detects the stop instruction during the first prohibition interval under the control of wide-angle energization, the control logic circuit waits for an end of the first prohibition interval and fixes the upper arm of the source phase to be off.

3. The driving circuit of claim 1, wherein
the control logic circuit is capable of controlling the three-phase DC motor by a control of wide-angle energization,
in the bridge circuit, a predetermined width starting from a switching of a sink phase into which the current flows, is defined as a first prohibition interval, and
when the control logic circuit detects the stop instruction during the first prohibition interval under the control of wide-angle energization, the control logic circuit fixes a lower arm of a sink phase in which the current flows in to be off in the bridge circuit, and then fixes the upper arms and the lower arms of all phases of the bridge circuit to be off.

4. The driving circuit of claim 1, wherein
the control logic circuit is capable of controlling the three-phase DC motor by a two-phase modulation (down manner) of a 180-degree energization control,
a period is defined as a first permission interval when a number of source phases is two, and
the control logic circuit waits until the next first permission interval and fixes the upper arms and lower arms of the two source phases to be off when the stop instruction is detected outside the first permission interval during operation under the two-phase modulation (down manner).

5. The driving circuit of claim 2, wherein
the control logic circuit is capable of controlling the three-phase DC motor by a two-phase modulation (down manner) of a 180-degree energization control,
a period is defined as a first permission interval when a number of source phases is two, and
the control logic circuit waits until the next first permission interval and fixes the upper arms and lower arms of the two source phases to be off when the stop instruction is detected outside the first permission interval during operation under the two-phase modulation (down manner).

6. The driving circuit of claim 3, wherein
the control logic circuit is capable of controlling the three-phase DC motor by a two-phase modulation (down manner) of a 180-degree energization control,
a period is defined as a first permission interval when a number of source phases is two, and
the control logic circuit waits until the next first permission interval and fixes the upper arms and lower arms of the two source phases to be off when the stop instruction is detected outside the first permission interval during operation under the two-phase modulation (down manner).

7. The driving circuit of claim 4, wherein the first permission interval has a predetermined width that includes a timing at which output voltages of the two phases outputting a non-low voltage intersect.

8. The driving circuit of claim 5, wherein the first permission interval has a predetermined width that includes a timing at which output voltages of the two phases outputting a non-low voltage intersect.

9. The driving circuit of claim 4, wherein
the control logic circuit is capable of controlling the three-phase DC motor by a two-phase modulation (up and down manner) of a 180-degree energization control,
a period is defined as a second permission interval when a number of source phases is two,
the control logic circuit waits until the next second permission interval and fixes the upper arms and lower arms of the two source phases to be off when the stop instruction is detected outside the second permission interval during operation under the two-phase modulation (up and down manner).

10. The driving circuit of claim 5, wherein
the control logic circuit is capable of controlling the three-phase DC motor by a two-phase modulation (up and down manner) of a 180-degree energization control,
a period is defined as a second permission interval when a number of source phases is two,
the control logic circuit waits until the next second permission interval and fixes the upper arms and lower arms of the two source phases to be off when the stop instruction is detected outside the second permission interval during operation under the two-phase modulation (up and down manner).

11. The driving circuit of claim 9, wherein the second permission interval has a predetermined width that includes a timing at which output voltages of the two phases outputting a non-low voltage intersect.

12. A driving circuit, which is a driving circuit of a three-phase DC motor, the driving circuit comprising:
a control logic circuit for controlling a bridge circuit connected to the three-phase DC motor, wherein
the control logic circuit, in response to a stop instruction, fixes a lower arm of a sink phase in which a current flows in to be off in the bridge circuit, and then
fixes the upper arms and the lower arms of all phases of the bridge circuit to be off.

13. The driving circuit of claim 12, wherein
the control logic circuit is capable of controlling the three-phase DC motor by a control of wide-angle energization,
a predetermined width starting from a switching of an upper arm of a source phase in which a current flows out is defined as the second prohibition interval,
when the control logic circuit detects the stop instruction during the second prohibition interval under the control of wide-angle energization, the control logic circuit waits for an end of the second prohibition interval and fixes the lower arm of the sink phase to be off.

14. The driving circuit of claim 12, wherein
the control logic circuit is capable of controlling the three-phase DC motor by a two-phase modulation (up and down manner) of a 180-degree energization control,
a period is defined as a third permission interval when a number of sink phases is two,
the control logic circuit waits until the next third permission interval and fixes the lower arm of the two source phases to be off when the stop instruction is detected outside the third permission interval during operation under the two-phase modulation (up and down manner).

15. The driving circuit of claim 14, wherein the third permission interval has a predetermined width that includes a timing at which output voltages of the two phases outputting a non-high voltage intersect.

16. The driving circuit of claim 1, further comprising the bridge circuit.

17. The driving circuit of claim 1, wherein the driving circuit is integrally integrated on a semiconductor substrate.

18. The driving circuit of claim 1, wherein the three-phase DC motor is a fan motor.

19. A cooling device, comprising:
a fan motor; and
the driving circuit of claim 1 for driving the fan motor.

20. An electronic machine, comprising:
a processor;
a fan motor, cooling the processor; and
the driving circuit of claim 1 for driving the fan motor.
